(19) United States
(12) Patent Application Publication
(10) Pub. No.: US 2020/0156514 A1
(43) Pub. Date: May 21, 2020

(54) Seat Stand And Method Of Using Same

(71) Applicant: Do-Cal Enterprises, LLC, Frankfort, KY (US)

(72) Inventors: Allen Sweeney, Frankfort, KY (US); Donald L. Rice, Frankfort, KY (US)

(21) Appl. No.: 16/568,487

(22) Filed: Sep. 12, 2019

Related U.S. Application Data
(60) Provisional application No. 62/769,631, filed on Nov. 20, 2018.

(51) Int. Cl. B60N 2/32; A47C 4/02; A47C 4/28

(52) U.S. Cl. CPC B60N 2/32; A47C 4/28; A47C 4/02

(57) ABSTRACT

A seat stand for use with a seat removed from a vehicle and method is disclosed. The vehicle has a retaining member and a retaining pin spaced apart by a distance Dv. The seat stand includes a support base and a retaining member having at least one slot. The retaining member is coupled to the support base. An attachment member is coupled to an upper wall of the support base and spaced apart from the retaining member a distance Ds. A front leg is pivotably coupled to the support base and is movable between a stowed position and an open position. Similarly, a rear leg is pivotably coupled to the support base and is movable between a stowed position and an open position. In one embodiment, the distance Ds is substantially the same as the distance Dv.

### RELATED APPLICATION

The present application claims priority to U.S. Provisional Patent Application No. 62/769,631 filed Nov. 20, 2018, the disclosure of which is hereby incorporated herein by reference in its entirety.

### TECHNICAL FIELD

The invention generally relates to a seat stand and, more particularly, to a seat stand for use with removable seats from side-by-side off road vehicles and methods for using same.

### BACKGROUND

Side-by-side off road vehicles are very popular. They are ideally suited to transport 2-6 people into a variety of off road environments. Often one or more side-by-side vehicles will travel into a backcountry setting to camp or sightsee. During or after a ride into the backcountry, the riders will stop for a rest break, to fix a meal, or setup a campsite. In each of those instances, the riders may like to sit in a chair as opposed to on the ground, which may be wet or muddy. While side-by-sides may carry several passengers, they typically are not configured to also carry a lot of extra gear such as folding chairs.

One particular side-by-side is the Polaris™ RZR. The Polaris™ RZR has seats that may be removed from the vehicle so that the inside of the vehicle may be washed out after a ride in a muddy environment or to gain access to equipment under the seats, for example. Riders may also remove the seats when they take a break or reach a campsite, place them on the ground, and then sit on them. This is not an ideal situation because their legs have to rest directly on the ground which could be wet and muddy. In addition, the bottom of the seat may get wet and muddy, which may require cleaning before the seat is reinstalled into the Polaris RZR.

Accordingly, there exists a need to provide a way to provide exterior seating for riders of side-by-side vehicles and keep the seat off the ground so the rider may sit in a more upright position.

### SUMMARY OF THE INVENTION

The invention contemplates a seat stand for use with a seat removed from a vehicle, such as an off road side-by-side vehicle. The vehicle would have a retaining member and a retaining pin spaced apart by a distance Dv, where the retaining member and the retaining pin are configured to selectively secure the seat to the vehicle. The seat stand includes a support base having an upper wall with left and right spaced apart, opposing edges and front and back spaced-apart, opposing edges. The support base has left and right side walls coupled to and extending downwardly from the left and right edges, respectively, and front and rear side walls coupled to and extending downwardly from the front and rear edges, respectively. The seat stand includes a retaining member with at least one slot. The retaining member is coupled to the support base. The seat stand also includes an attachment member coupled to the upper wall and spaced apart from the retaining member a distance Ds. The seat stand further includes a front leg pivotably coupled to the support base, where the front leg is movable between a stowed position and an open position. The seat stand also includes a rear leg pivotably coupled to the support base, where the rear leg is movable between a stowed position and an open position. In one aspect, the attachment member includes a notch configured to releasably engage a release member on a seat removed from a vehicle. In one embodiment, the distance Ds is substantially the same as the distance Dv. In one embodiment, Ds is approximately 13 inches.

In one embodiment, the front and rear legs are generally U-shaped and each of the front and rear legs is pivotably coupled to the left and ride side walls with a fastener assembly. The fastener assembly may include a bolt.

In one embodiment, the left and right side walls have first and second front holes proximate the front side wall and first and second rear holes proximate the rear side wall. Each leg has a hole proximate one end on the leg. The seat stand further includes a pin sized to fit the front and rear holes in the left and right side walls and the hole in each leg, wherein when the pin is inserted into the first front hole and the hole in the front leg, the front leg is secured in the stowed position, and when the pin is inserted into the second front hole and hole in the front leg, the front leg is secured in the open position. In one aspect, each of the front and rear legs is pivotably coupled to the left and ride side walls with a fastener assembly and the pin includes a connector attaching the pin to the fastener assembly. In another aspect, the connector is flexible and long enough so that the pin may be inserted first into the front and rear holes and then into the hole in the front and rear legs or inserted first into the hole in the front and rear legs and then into the front and rear holes.

In one embodiment, the retaining member is operatively coupled to the front side wall and projects upwardly therefrom and the attachment member is coupled to the upper wall proximate the rear side wall. The attachment member may be substantially centered between the left and right side walls.

In another embodiment, a seat stand for use with a seat removed from a vehicle where the vehicle has a retaining member and a retaining pin spaced apart by a distance Dv, includes a support base and a retaining member having at least one slot, where the retaining member is coupled to the support base. The seat stand includes an attachment member coupled to an upper wall of the support base and spaced apart from the retaining member a distance Ds. A front leg is pivotably coupled to the support base and is movable between a stowed position and an open position. A rear leg is pivotably coupled to the support base and is movable between a stowed position and an open position. In one embodiment, the distance Ds is substantially the same as the distance Dv.

The invention also contemplates a method for installing a seat removed from a vehicle onto a seat stand where the seat has at least one tab on a front portion of the seat and a hole proximate a rear portion of the seat. The method includes providing a seat stand including a support base, a retaining member and an attachment member coupled to the support base. The attachment member is spaced apart from the retaining member. The seat stand also includes front and rear legs pivotably coupled to the support base and movable between a stowed position and an open position. The method also includes moving the front and rear legs to the open position; coupling the tab on the seat removed from the vehicle to the retaining member; and engaging the hole of the seat to the attachment member.

In one embodiment, the retaining member has at least one slot, and coupling the tab on the seat to the retaining member includes inserting the tab into the slot. In another embodiment, the hole in the seat includes a release member and the attachment member includes a notch, and engaging the hole of the seat to the attachment member includes inserting the attachment member into the hole such that the release member engages the notch in the attachment member. In yet another embodiment, the seat stand includes a pin, and moving the front and rear legs to the open position includes engaging the front leg with the pin to secure the front leg in the open position.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a seat stand installed in a side-by-side off road vehicle.

FIG. 2 is a perspective view of the seat stand of FIG. 1 removed from the side-by-side off road vehicle.

FIG. 3 is a perspective view of the seat stand according to one embodiment with the legs folded to the stowed position.

FIG. 4 is a perspective view of the seat stand of FIG. 3 with base shown in phantom for clarity.

FIG. 5A is a cross-sectional view of the seat stand of FIG. 3 taken along line 5-5.

FIG. 5B is a cross-sectional view of the seat stand of FIG. 3 taken along line 5-5 with the legs unfolded to the open position.

FIG. 6 is a perspective view of the seat stand of FIG. 1 illustrating how it attaches to the seat stand of FIG. 3.

FIG. 7 is a perspective view of the seat stand of FIG. 1 attached to the seat stand of FIG. 3 with the legs unfolded.

### DETAILED DESCRIPTION OF THE INVENTION

The present invention provides a seat stand with foldable legs for use with the removable seats from side-by-side vehicles, especially side-by-sides manufactured by Polaris. While the description below is specific to the removable seats from Polaris side-by-side vehicles, the invention could be readily adapted to accommodate the removable seats from other off road vehicles manufactured by other companies.

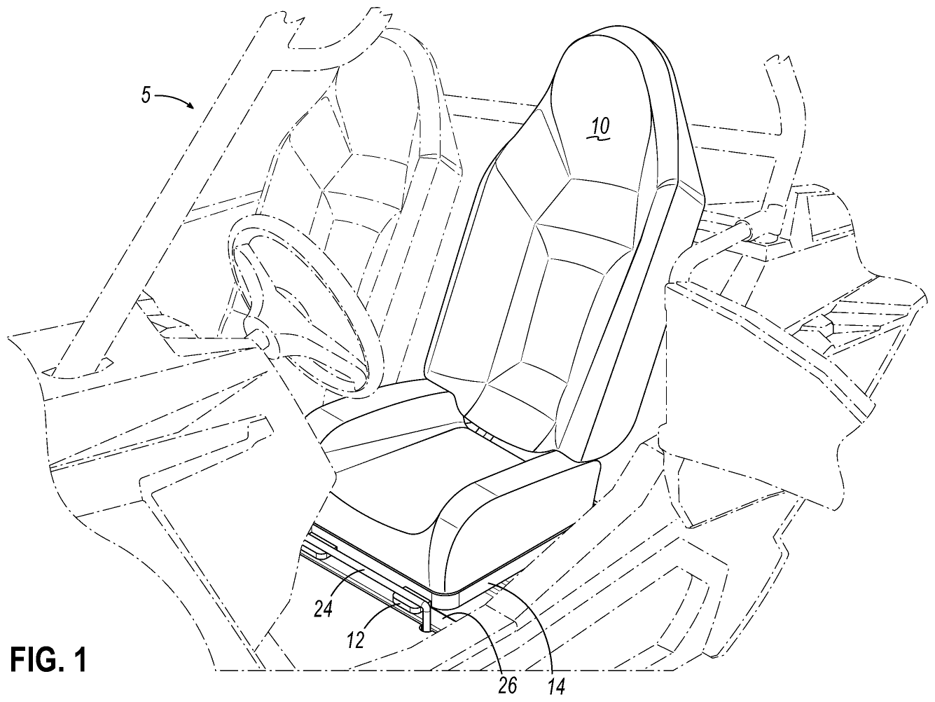

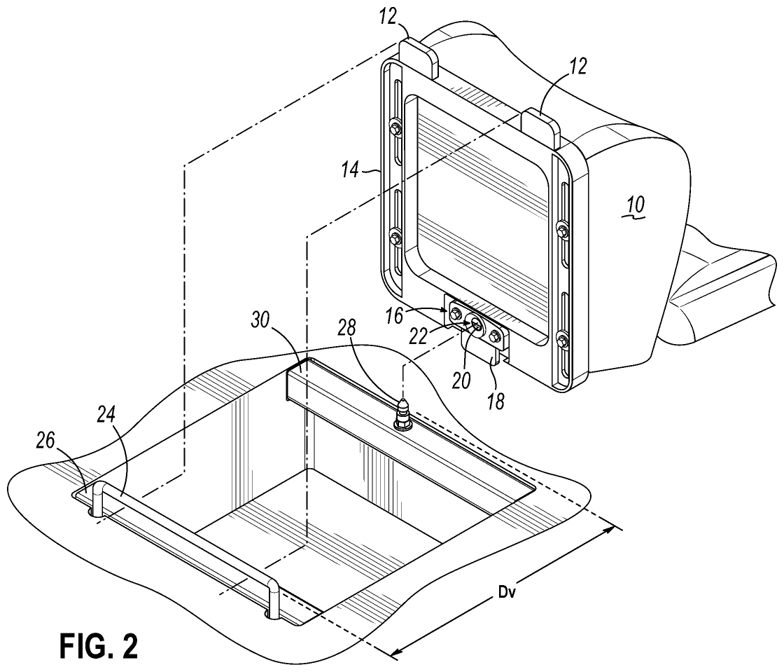

By way of background, FIG. 1 illustrates a driver's seat 10 installed in an exemplary Polaris side-by-side vehicle (illustrated in dashed lines) 5. FIG. 2 illustrates the driver's seat 10 removed from the side-by-side vehicle 5. The seat 10 has two tabs 12 extending from a front edge of a base 14. The seat 10 further includes a quick release mechanism 16 positioned along a rear edge of the base 14. The quick release mechanism 16 includes a handle 18 that is operatively connected to a release member 20, such as a bar located within a hole 22. When operated, the handle 18 moves the release member 20 out of the hole 22 such that the release member 20 does not intrude into the hole 22. The side-by-side vehicle 5 includes a retaining member 24 affixed to a front seat frame 26 and a retaining pin 28 affixed to a rear seat frame 30. When the seat is installed in the side-by-side vehicle 5 (FIG. 1), the tabs 12 are inserted underneath the retaining member 24 and the hole 22 is aligned with and dropped onto the retaining pin 28. The bar 20 engages a groove in the retaining pin 28 so as to secure the seat 10 to the interior of the side-by-side vehicle 5. To remove the seat 10 from the side-by-side vehicle 5, the user operates the handle 18 to move bar 20 away from the groove in the retaining pin 28, pivots the rear of the seat upwardly about the retaining member 24 so that the tabs 12 may be pulled out from underneath the retaining member 24 to thereby release the seat 10 from the interior of the side-by-side vehicle 5. The retaining member 24 and retaining pin 28 are spaced apart by a distance Dv (FIG. 2).

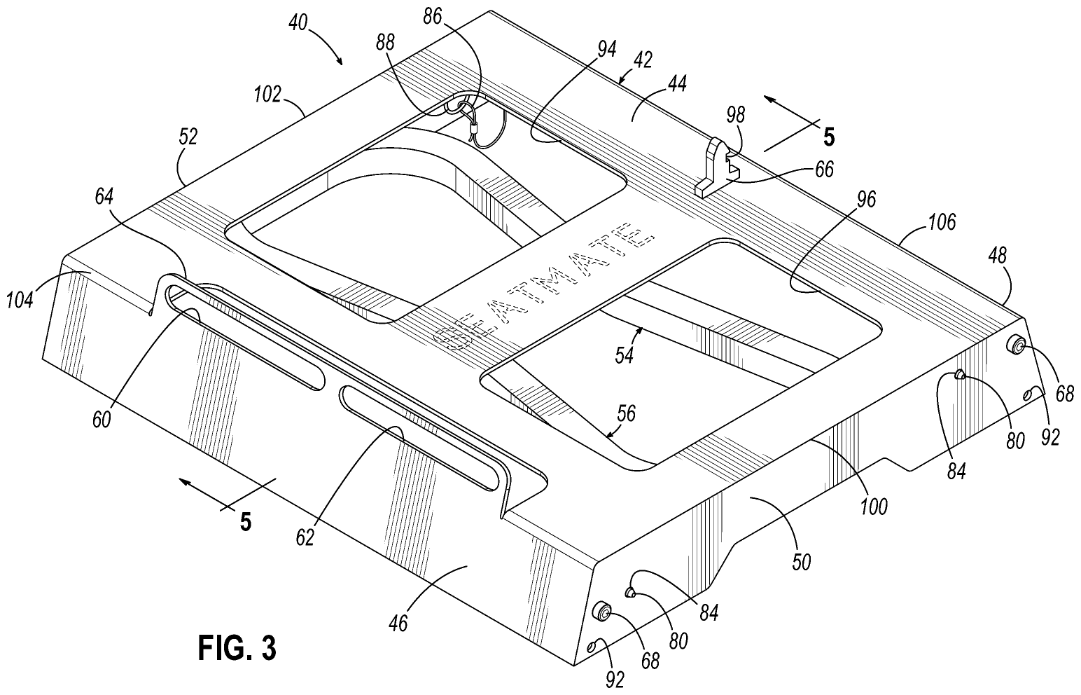

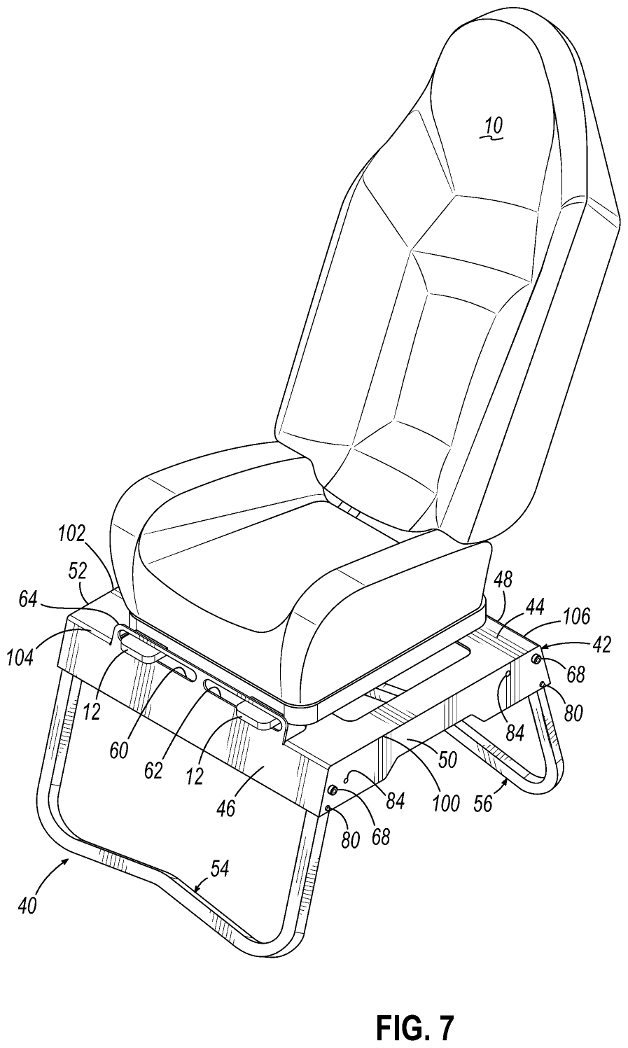

With reference to FIG. 3, an exemplary embodiment of a seat stand 40 is illustrated in accordance with the principles of the invention. The seat stand 40 has support base 42 that has an upper wall 44, front and rear side walls 46, 48, and left and right side walls 50, 52. The upper wall has left and right spaced-apart, opposing edges 100, 102 and front and rear spaced apart, opposing edges 104, 106, where the edges 100, 102, 104, 106 define a generally rectangular boundary of the upper wall 44. The left and right side walls 50, 52 are coupled to and extend downwardly from the left and right edges 100, 102, respectively. Similarly, the front and rear side walls 46, 48 are coupled to and extend downwardly from the front and rear edges 104, 106, respectively. The seat stand 40 includes front and rear legs 54, 56 pivotably attached to the left and right side walls 50, 52 via a fastener assembly 58. The support base 42 also includes slots 60, 62, which are formed in a retaining member 64 operatively coupled to the front side wall 46, and an attachment member 66 affixed to the upper wall 44. In one embodiment, the retaining member 64 may be operatively coupled to the upper wall 44 instead of the front side wall 46. In one embodiment, the attachment member 66 is positioned substantially centered between the left and right side walls 50, 52. For orientation purposes only, the terms “front,” “rear,” “left,” and “right,” used herein refer to a person's front, rear (back), left, and right when that person is sitting in the seat 10 attached to the seat stand 40 (FIG. 7). With that orientation in mind, the slots 60, 62 are considered to be at the front of the support base 42 and the attachment member 66 is considered to be at the rear of the support base 42. This orientation corresponds to the front and back of the seat 10 when it is attached to the support base 42. While two slots 60, 62 in the retaining member 64 are illustrated in the figures, one continuous slot may alternatively be located in retaining member 64.

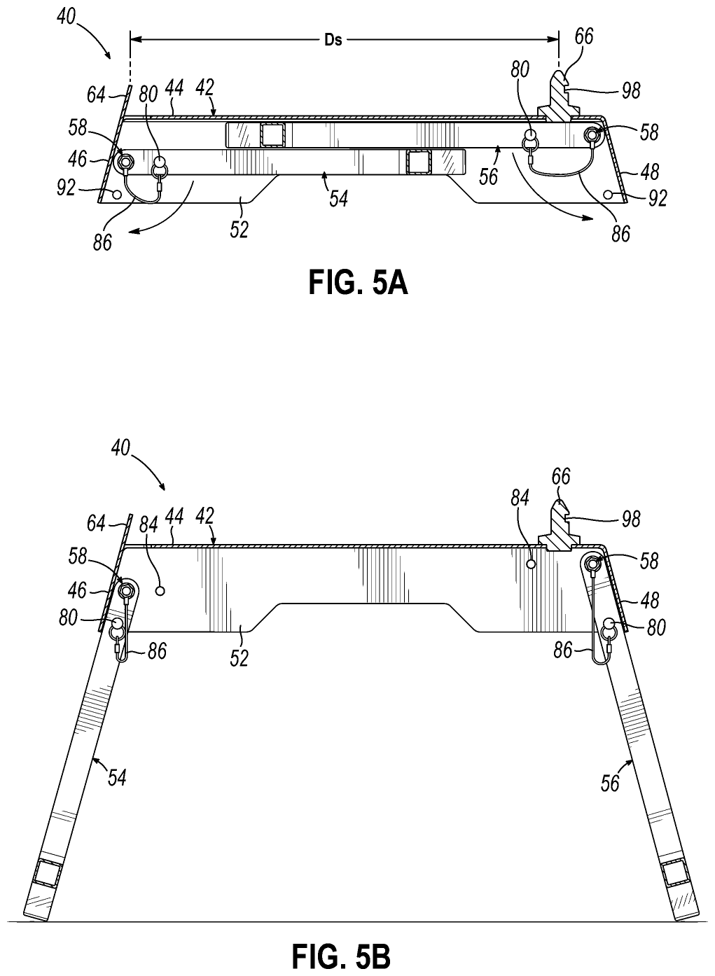

Each fastener assembly 58 includes a fastener such as bolt 68 which passes through a hole (not shown) in the left and right side walls 50, 52 and through a corresponding hole 70 in each leg 54, 56. The fastener assembly 58 further includes low-friction, inner and outer bushings 72, 74, a flat washer 76, and a nut 78. The legs 54, 56 are movable between a stowed position (FIGS. 3-5A) and an open position (FIG. 5B-7).

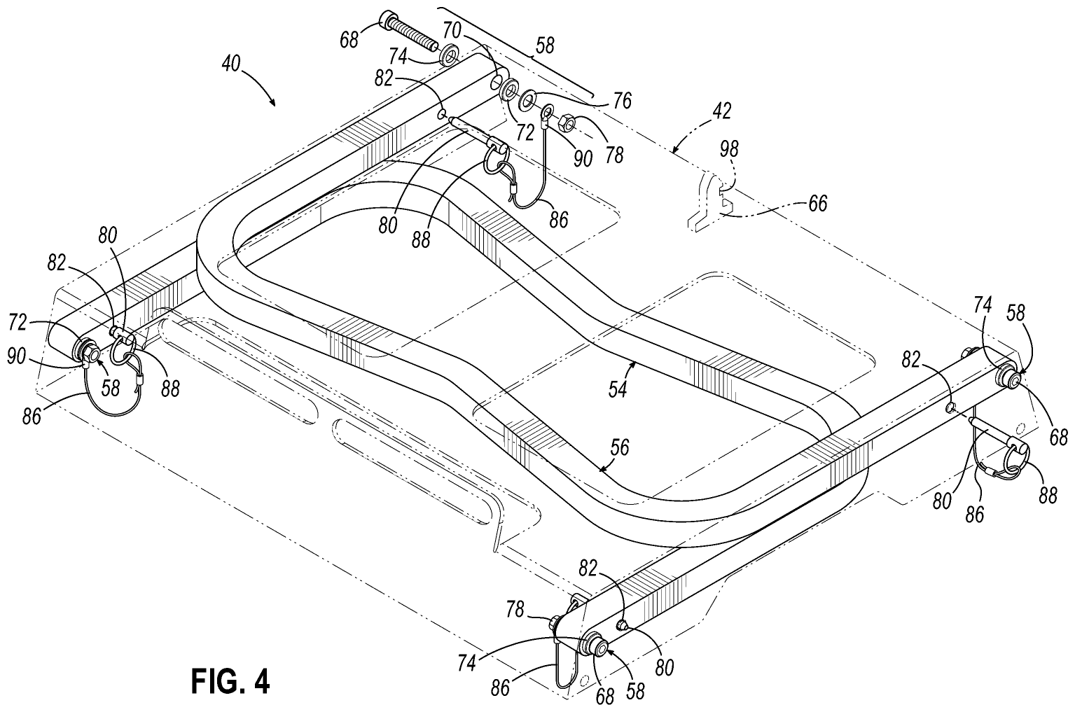

To secure the legs 54, 56 in the stowed position, a removable pin 80 is inserted into a hole 82 in the legs 54, 56 and through a corresponding hole 84 in the left and right side walls 50, 52. The pin 80 is operatively coupled to the fastener assembly via a flexible connector 86 with one end 88 attached to the end of the pin 80 and another end 90 attached to the fastener assembly 58. The flexible connector 86 is long enough such that the pin 80 may be inserted through holes 82, 84 from the inside of the support base 42 as shown in FIG. 3 or the pin 80 may be inserted through holes 82, 84 from the outside of the support base as shown at the left rear corner of the support base 42 in FIG. 4. To secure the legs 54, 56 in the open position, the removable pin 80 is inserted in hole 82 in the legs 54, 56 and through a corresponding hole 92 in the left and right side wall 50, 52 (FIG. 3). Holes 84, 92 in the left and right side walls 50, 52 are grouped such that a pair of holes 84, 92 are proximate the front side wall 46 and a pair of holes 84, 92 are proximate the rear side wall 48.

As shown in FIG. 5B, the length of the legs 54, 56 are sized such that the upper wall 44 of the support base 42 is substantially level. In one embodiment, the legs 54, 56 could be sized such that the upper wall 44 of the support base 42 is slanted backwards or slanted forwards to accommodate seats from different manufacturers. Also, while the legs 54, 56 are made from a continuous piece of material formed in a generally U-shaped configuration, it will be appreciated that the legs 54, 56 could be made from individual pieces such that the support base 42 would be supported by four individual legs at each of the four corners of the support base 42. The U-shaped configuration provides a larger contact surface area to spread out the weight of the seat stand 40, the seat 10, and the person in the seat 10 on the ground or other suitable support surface. If four individual legs are used, the contact surface area is much less, and the individual legs may pierce deeply into the ground. Of course, individual legs would be suitable if the seat stand were used on hard surface such as concrete, asphalt, or the like.

The support base 42 and legs 54, 56 are preferably constructed from high strength materials that are also lightweight. For instance, the support base 42 and legs 54, 56 may be made from steel, aluminum, plastic, polymers, composites, and the like. To further reduce the weight of the support base 42, openings 94, 96 may be cut into the upper wall 44. Care must be used to not make the openings 94, 96 too large so as to impact the rigidity, integrity, and long-term durability of the support base 42.

Although not intended to be limited to any particular dimensions, in one embodiment the support base 42 may be between 16 to 20 inches wide (left to right), may be between 13 to 17 inches deep (front to back), and may be between 2 to 4 inches tall. In order for a standard seat from a Polaris™ RZR side-by-side vehicle to attach to the support base 42, the distance Ds (FIG. 5A) between the slots 60, 62 and the attachment member 66 should be in the range of 12-14 inches and preferably approximately 13 inches. As will be appreciated, in order for the seat 10 to attach to the seat stand 40, the distance Ds should be substantially equal to the distance Dv. Other distances (Ds) may be used to accommodate different distances (Dv) used on either different Polaris models or by different side-by-side vehicle manufacturers. In one embodiment, the legs may be between 10 to 14 inches tall and may be constructed of ¾ inch square tube. In one embodiment, the attachment member 66 extends approximately 1.2 to 1.4 inches above the surface of the upper wall 44 to substantially match the height of the retaining pin used in the Polaris™ RZR illustrated in FIGS. 1 and 2.

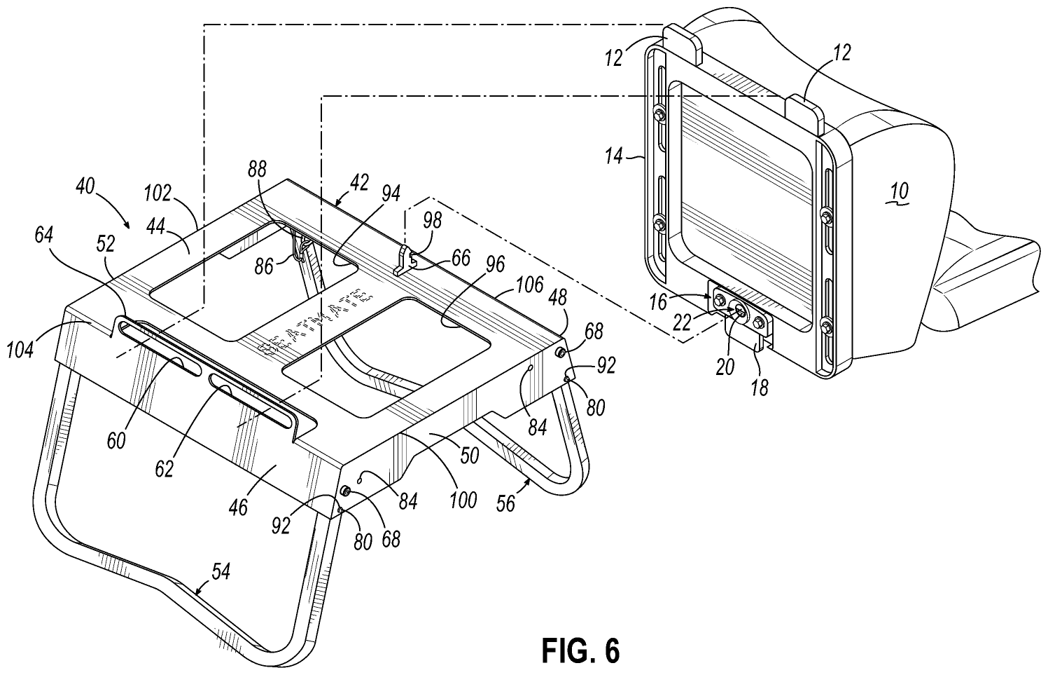

In the embodiment described above, the front and rear legs 54, 56 are pivotably attached to the left and right side walls 50, 52. In another embodiment, the front and rear legs 54, 56 may be pivotably attached to the front and rear side walls 46, 48 where the holes are located in the front and rear side walls 46, 48 instead of being located in the left and right side walls 50, 52 as illustrated. In this configuration, the rear legs 54, 56 in the open position would be positioned on the left and right sides of the seat stand 40, respectively, as opposed to the front and rear sides (FIG. 6). The holes 84, 92 would also be on the front and rear side walls 46, 48 to receive a pin 80 to hold the rear legs 54, 56 in either the stowed or open positions.

The invention also contemplates a method for installing the seat 10 removed from the side-by-side vehicle 5 onto the seat stand 40. Thus, in use, the driver of the side-by-side vehicle 5 would typically ride with the seat stand 40 inside the vehicle 5 (with the legs 54, 56 in the stowed position). When the driver reaches a stopping point, such as for lunch or to camp, the driver (or another person) would remove the seat stand 40 from the vehicle 5. The driver would pull the pins 80 from holes 82, 84 and then rotate the legs 54, 56 from the stowed position to the open position and then insert the pins 80 into holes 84, 92 as depicted in FIG. 6. The driver would then place the seat stand 40 on the ground or other suitable support surface. The driver would then insert tabs 12 on the seat 10 into the slots 60, 62 on the support base 42. The driver would then rotate the rear of the seat 10 downward until the hole 22 on the seat 10 aligns with and engages the attachment member 66. More specifically, the release member 20 in the seat 10 would engage with a notch 98 in the attachment member 66. At this point, the seat 10 is attached to the seat stand 40 (FIG. 7) in essentially the same way that the seat 10 attaches to the vehicle 5 (FIG. 1). When the driver wishes to pack up the seat stand 40, he would reverse the steps described above starting with operating the handle 18 so as to release the hole 22 from the attachment member 66.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A seat stand for use with a seat removed from a vehicle where the vehicle has a retaining member and a retaining pin spaced apart by a distance Dv, the seat stand comprising:
a support base having an upper wall with left and right spaced apart, opposing edges and front and back spaced-apart, opposing edges, the support base having left and right side walls coupled to and extending downwardly from the left and right edges, respectively, and front and rear side walls coupled to and extending downwardly from the front and rear edges, respectively;
a retaining member having at least one slot, the retaining member coupled to the support base;
an attachment member coupled to the upper wall and spaced apart from the retaining member a distance Ds;
a front leg pivotably coupled to the support base, the front leg being movable between a stowed position and an open position; and
a rear leg pivotably coupled to the support base, the rear leg being movable between a stowed position and an open position,
wherein the distance Ds is substantially the same as the distance Dv.

2. The seat stand of claim 1, wherein the front and rear legs are generally U-shaped, each of the front and rear legs being pivotably coupled to the left and ride side walls with a fastener assembly.

3. The seat stand of claim 2, wherein the fastener assembly include a bolt.

4. The seat stand of claim 1, wherein the left and right sides walls have first and second front holes proximate the front side wall and first and second rear holes proximate the rear side wall, each leg having a hole proximate one end on the leg, the seat stand further comprising a pin sized to fit the front and rear holes in the left and right side walls and the hole in each leg, wherein when the pin is inserted into the first front hole and the hole in the front leg the front leg is secured in the stowed position, and when the pin is inserted into the second front hole the and hole in the front leg the front leg is secured in the open position.

5. The seat stand of claim 4, wherein each of the front and rear legs is pivotably coupled to the left and ride side walls with a fastener assembly, and wherein the pin includes a connector attaching the pin to the fastener assembly.

6. The seat stand of claim 5, wherein the connector is flexible and long enough so that the pin may be inserted first into the front and rear holes and then into the hole in the front and rear legs or inserted first into the hole in the front and rear legs and then the into front the front and rear holes.

7. The seat stand of claim 1, wherein the attachment member includes a notch configured to releasably engage a release member on a seat removed from a vehicle.

8. The seat stand of claim 1, where Ds is approximately 13 inches.

9. The seat stand of claim 1, wherein the retaining member is operatively coupled to the front side wall and projects upwardly therefrom and the attachment member is coupled to the upper wall proximate the rear side wall.

10. The seat stand of claim 9, wherein the attachment member is substantially centered between the left and right side walls.

11. A seat stand for use with a seat removed from a vehicle where the vehicle has a retaining member and a retaining pin spaced apart by a distance Dv, the seat stand comprising:
a support base;
a retaining member having at least one slot, the retaining member coupled to the support base;
an attachment member coupled to an upper wall of the support base and spaced apart from the retaining member a distance Ds;
a front leg pivotably coupled to the support base, the front leg being movable between a stowed position and an open position; and
a rear leg pivotably coupled to the support base, the rear leg being movable between a stowed position and an open position,
wherein the distance Ds is substantially the same as the distance Dv.

12. The seat stand of claim 11, further comprising a selectably removable pin configured engage the front leg to secure it to the support base in either the stowed position or the open position.

13. The seat stand of claim 11, wherein the attachment member includes a notch configured to releasably engage a release member on the seat removed from the vehicle.

14. The seat stand of claim 11, where Ds is approximately 13 inches.

15. A method for installing a seat removed from a vehicle onto a seat stand, the seat having at least one tab on a front portion of the seat and a hole proximate a rear portion of the seat, the method comprising:
providing a seat stand including a support base, a retaining member and an attachment member coupled to the support base, the attachment member spaced apart from the retaining member, front and rear legs pivotably coupled to the support base and movable between a stowed position and an open position;
moving the front and rear legs to the open position;
coupling the tab on the seat removed from the vehicle to the retaining member; and
engaging the hole of the seat to the attachment member.

16. The method of claim 15, wherein the retaining member has at least one slot, and coupling the tab on the seat to the retaining member includes inserting the tab into the slot.

17. The method of claim 15, wherein the hole in the seat includes a release member and the attachment member includes a notch, and engaging the hole of the seat to the attachment member includes inserting the attachment member into the hole such that the release member engages the notch in the attachment member.

18. The method of claim 15, wherein the seat stand includes a pin, and moving the front and rear legs to the open position includes engaging the front leg with the pin to secure the front leg in the open position.
